(19) United States
(12) Patent Application Publication
(10) Pub. No.: US 2025/0284310 A1
(43) Pub. Date: Sep. 11, 2025

(54) Sensor Module And Measurement System

(71) Applicant: SEIKO EPSON CORPORATION, Tokyo (JP)

(72) Inventor: Fumikazu OTANI, Azumino (JP)

(21) Appl. No.: 19/074,770

(22) Filed: Mar. 10, 2025

(30) Foreign Application Priority Data
Mar. 11, 2024 (JP) 2024-036742

(51) Int. Cl. G06F 1/12

(52) U.S. Cl. CPC G06F 1/12

(57) ABSTRACT

A sensor module includes a first sensor device, a second sensor device, and a microcontroller. The microcontroller receives first detected data input from the first sensor device and second detected data input from the second sensor device. The microcontroller determines first integrated data by integrating the first detected data up to a synchronization timing of an external synchronization signal, determines second integrated data by integrating the second detected data up to the synchronization timing, and outputs the first integrated data and the second integrated data to a host device at the synchronization timing.

The present application is based on, and claims priority from JP Application Serial Number 2024-036742, filed Mar. 11, 2024, the disclosure of which is hereby incorporated by reference herein in its entirety.

### BACKGROUND

### 1. Technical Field

The present disclosure relates to a sensor module, a measurement system, and the like.

### 2. Related Art

JP-A-2022-72338 discloses an inertia measuring apparatus. The inertia measuring apparatus includes an angular velocity sensor and an acceleration sensor that output inertia information, a storage that stores multiple correction parameters relating to the range of the value of the inertia information, a parameter control section that selects a selected correction parameter from the multiple correction parameters, and a correction operation section that corrects the inertia information by using the selected correction parameter.

JP-A-2022-072338 is an example of the related art.

The inertia measuring apparatus described above outputs angular velocity data and acceleration data, so that there is a problem of a large load on another apparatus that receives the data. For example, the communication between the inertia measuring apparatus and the other apparatus is performed at a high rate, so that there is a problem of a large communication load, or a large load on the other apparatus that processes the angular velocity data and the acceleration data.

### SUMMARY

An aspect of the present disclosure relates to a sensor module including: a first sensor device including a first sensor element, a first detection circuit configured to receive a signal input from the first sensor element and perform detection, and a first interface configured to output first detected data from the first detection circuit; a second sensor device including a second sensor element, a second detection circuit configured to receive a signal input from the second sensor element and perform detection, and a second interface configured to output second detected data from the second detection circuit; and a microcontroller including a synchronization terminal to which an external synchronization signal is input and configured to receive the first detected data input from the first sensor device and the second detected data input from the second sensor device, the microcontroller configured to determine first integrated data by integrating the first detected data up to a synchronization timing of the external synchronization signal, determine second integrated data by integrating the second detected data up to the synchronization timing, and output the first integrated data and the second integrated data to a host device at the synchronization timing.

Another aspect of the present disclosure relates to a measurement system including the sensor module described above; and the host device electrically coupled to the sensor module.

### BRIEF DESCRIPTION OF THE DRAWINGS

FIG. 1 shows an exemplary configuration of a sensor module.

FIG. 2 is an exemplary timing chart illustrating the operation of a microcontroller.

FIG. 3 shows a first exemplary configuration of the microcontroller.

FIG. 4 is a signal waveform diagram for illustrating the operation of the sensor module.

FIG. 5 shows a second exemplary configuration of the microcontroller.

FIG. 6 is an exemplary timing chart for illustrating the operation of the microcontroller in the second exemplary configuration.

FIG. 7 is a signal waveform diagram for illustrating the operation of the sensor module using the microcontroller having the exemplary second configuration.

FIG. 8 shows an exemplary configuration of a sensor device.

FIG. 9 shows an exemplary configuration of an angular velocity sensor device.

FIG. 10 shows an exemplary configuration of a measurement system.

FIG. 11 shows an exemplary configuration of an electronic instrument.

### DESCRIPTION OF EMBODIMENTS

A preferred embodiment of the present disclosure will be described below in detail. The present embodiment described below does not unduly limit the contents described in the claims, and all configurations described in the present embodiment are not necessarily essential configuration requirements of the present disclosure.

### 1. Exemplary Configuration of Sensor Module

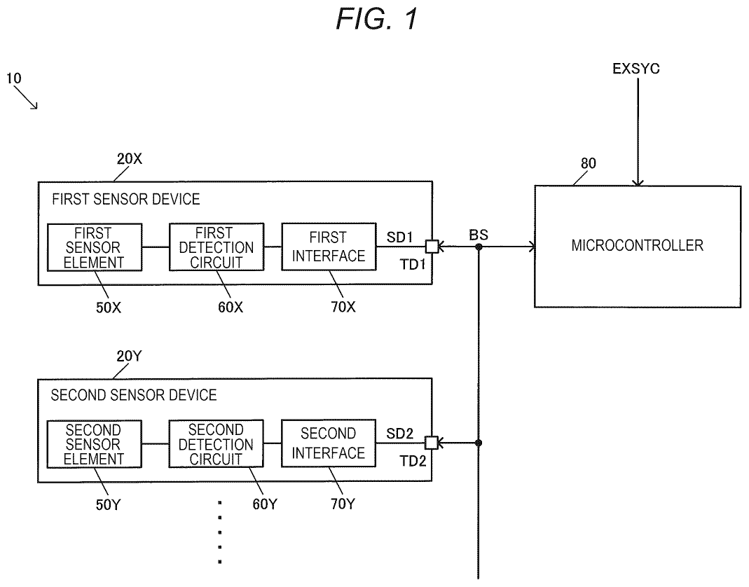

FIG. 1 shows an exemplary configuration of a sensor module 10 according to the present embodiment. The sensor module 10 is a physical quantity detecting module configured with multiple sensor devices, and the sensor module 10 provides a sensor system or a sensor unit. The sensor module 10 shown in FIG. 1 includes a first sensor device 20X, a second sensor device 20Y, and a microcontroller 80. Note that the sensor module 10 does not necessarily have the configuration shown in FIG. 1, and may be variously modified by omitting some of the elements that constitute the sensor module 10 or adding other elements thereto. For example, FIG. 1 shows an exemplary case where the number of the sensor devices is two, but the number of the sensor devices may be three or more. For example, the sensor module 10 according to the present embodiment may include a first sensor device to an n-th sensor device. The symbol n is an integer greater than or equal to two.

The first sensor device 20X includes a first sensor element 50X, a first detection circuit 60x, which receives a signal input from the first sensor element 50X and performs detection, and a first interface 70X, which outputs first detected data SD1 from the first detection circuit 60X. The first sensor device 20X is a device in which the first sensor element 50X, and an integrated circuit unit including the first detection circuit 60x and the first interface 70X are housed in a package. The integrated circuit unit is an IC chip realized by semiconductor.

The second sensor device 20Y includes a second sensor element 50Y, a second detection circuit 60Y, which receives a signal input from the second sensor element 50Y and performs detection, and a second interface 70Y, which outputs second detected data SD2 from the second detection circuit 60Y. The second sensor device 20Y is a device in which the second sensor element 50Y, and an integrated circuit unit including the second detection circuit 60Y and the second interface 70Y are housed in a package.

When the number of the sensor devices is three or more, and the n-th sensor device is provided, the n-th sensor device includes an n-th sensor element, an n-th detection circuit that receives a signal input from the n-th sensor element and performs detection, and an n-th interface that outputs n-th detected data from the n-th detection circuit.

The first sensor element 50X and the second sensor element 50Y are each a sensor element that detects a physical quantity, and may be called a physical quantity transducer. The physical quantity is, for example, angular velocity, acceleration, angular acceleration, velocity, distance, pressure, sound pressure, and the amount of magnetism. The first sensor element 50X and the second sensor element 50Y detect physical quantities different from each other. For example, when the physical quantity is angular velocity, the first sensor element 50X detects angular velocity around a first axis, and the second sensor element 50Y detects angular velocity around a second axis. Instead, when the physical quantity is acceleration, the first sensor element 50X detects acceleration in the direction of the first axis, and the second sensor element 50Y detects acceleration in the direction of the second axis. Still instead, the first sensor element 50X may detect a first physical quantity out of angular velocity, acceleration, angular acceleration, velocity, distance, pressure, and the amount of magnetism, which are physical quantities, and the second sensor element 50Y may detect a second physical quantity different from the first physical quantity. As an example, the first sensor element 50X detects angular velocity, and the second sensor element 50Y detects acceleration.

The first detection circuit 60X and the second detection circuit 60Y can each include an analog circuit and an A/D conversion circuit that converts an analog signal from the analog circuit into digital data. The analog circuit may include an amplification circuit that amplifies a signal from the sensor element, a wave detecting circuit such as a synchronous wave detecting circuit, a gain adjusting circuit, an offset adjusting circuit, or the like. The A/D conversion circuit outputs digital detected data to the interface. A/D conversion circuits classified to an A/D conversion type may include, for example, those of a successive comparison type, a delta-sigma type, a flash type, a pipeline type, and a double integration type.

The first interface 70X and the second interface 70Y are each, for example, a circuit that performs digital interfacing, for example, transmitting or receiving serial data. Specifically, the interfaces perform interfacing that complies with the SPI or I2C communication standard. The interfaces may perform interfacing that complies with an advanced SPI or I2C communication standard, or a partially improved or modified SPI or I2C communication standard.

The first detected data SD1 from the first sensor device 20X and the second detected data SD2 from the second sensor device 20Y are input to the microcontroller 80. The sensor module 10 includes a digital interface bus BS, which electrically couples the first sensor device 20X and the second sensor device 20Y to the microcontroller 80. The digital interface bus BS is a bus that complies with a communication standard in accordance with which the first interface 70X and the second interface 70Y perform the interfacing. The digital interface bus BS includes a data signal line, a clock signal line, and other lines. The digital interface bus BS may further carry a chip select signal. The microcontroller 80 receives the first detected data SD1 input from the first sensor device 20X and the second detected data SD2 input from the second sensor device 20Y via the digital interface bus BS. Note that the first interface 70X and that the second interface 70Y are electrically coupled to the digital interface bus BS via a terminal TD1 and a terminal TD2, respectively. The term “electrically coupled” used herein means coupling that allows an electrical signal transmission and information transmission through the electrical signal. The microcontroller 80 is a controller that serves as a master with respect to the first sensor device 20X and the second sensor device 20Y. The microcontroller 80 is an integrated circuit unit, and can be realized, for example, by a processor such as an MPU or a CPU. The microcontroller 80 may instead be an ASIC or an FPGA.

An external synchronization signal EXSYC is input to the microcontroller 80. The external synchronization signal EXSYC is a signal input from an external device to the sensor module 10 and becomes active at each synchronization timing. The external synchronization signal EXSYC is, for example, a signal that becomes active at regular intervals. The term “active” is a high level in the case of positive logic and a low level in the case of negative logic. For example, the external device may be a receiver of a satellite positioning system, and a PPS signal from the receiver may be input as the external synchronization signal EXSYC to the sensor module 10. Instead, the external device may be a host device for the sensor module 10, and the host device may generate the external synchronization signal EXSYC synchronized with the PPS signal, for example, by using a PLL. Still instead, the host device may acquire time information, for example, from an NTP service via a network, and generate the external synchronization signal EXSYC synchronized with the time information.

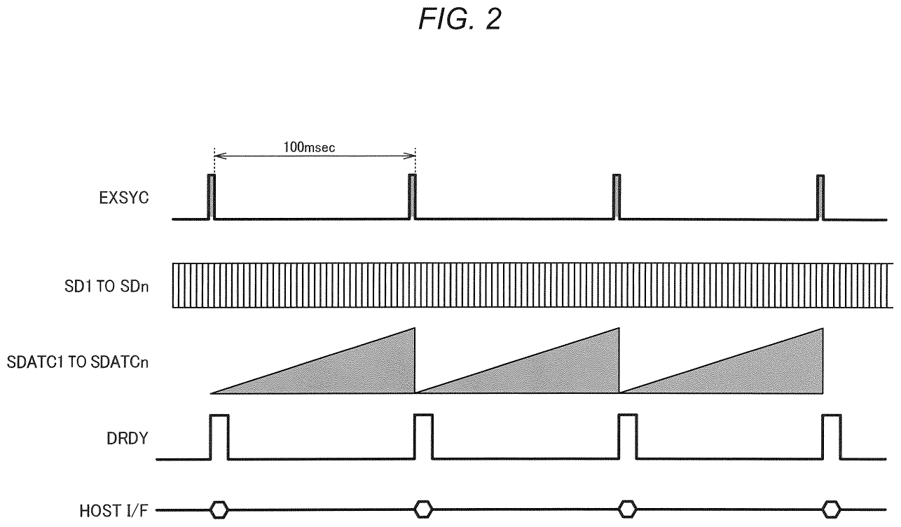

FIG. 2 is an exemplary timing chart illustrating the operation of the microcontroller 80. FIG. 2 shows a case where a 10-pulse/sec PPS signal is input as the external synchronization signal EXSYC to the microcontroller 80.

In the waveform of the first detected data SD1 to n-th detected data SDn, one quadrangle indicates one set of sampled data. The term “sampling” used herein means that the microcontroller 80 receives detected data from the interface of each of the sensor devices. Note that FIG. 2 shows only one waveform, but the microcontroller 80 samples each of the first detected data SD1 to the n-th detected data SDn.

The microcontroller 80 integrates the first detected data SD1 to determine first integrated data SDATC1. Similarly, the microcontroller 80 integrates the second detected data SD2 to the n-th detected data SDn to determine second integrated data SDATC2 to n-th integrated data SDATCn. FIG. 2 shows only the waveform of one set of integrated data in a case where the detected data is a constant value. The microcontroller 80 resets the first integrated data SDATC1 to the n-th integrated data SDATCn at an edge timing of the external synchronization signal EXSYC, and continues the integration until the edge timing of the next external synchronization signal EXSYC. The edge timing of the external synchronization signal EXSYC may be either the rising or falling timing of the external synchronization signal EXSYC.

The microcontroller 80 outputs the first integrated data SDATC1 to the n-th integrated data SDATCn as the result of the integration performed from the edge timing of the external synchronization signal EXSYC to the next edge timing thereof to the host device. Specifically, the microcontroller 80 holds the first integrated data SDATC1 to the n-th integrated data SDATCn immediately before reset at the edge timing of the external synchronization signal EXSYC, and outputs the held first integrated data SDATC1 to n-th integrated data SDATCn to the host device. A host interface of the microcontroller 80 is an interface that complies, for example, with SPI, I2C, or UART. When the host interface is an interface that complies with SPI, the microcontroller 80 generates a data ready signal DRDY at the edge timing of the external synchronization signal EXSYC and outputs the data ready signal DRDY to the host device. Upon reception of the data ready signal DRDY, the host device reads the first integrated data SDATC1 to the n-th integrated data SDATCn via the host interface of the microcontroller 80. Note that when the host interface is an interface that complies with I2C or UART, the data ready signal DRDY may be generated in the microcontroller 80 although the data ready signal DRDY is not used for communication.

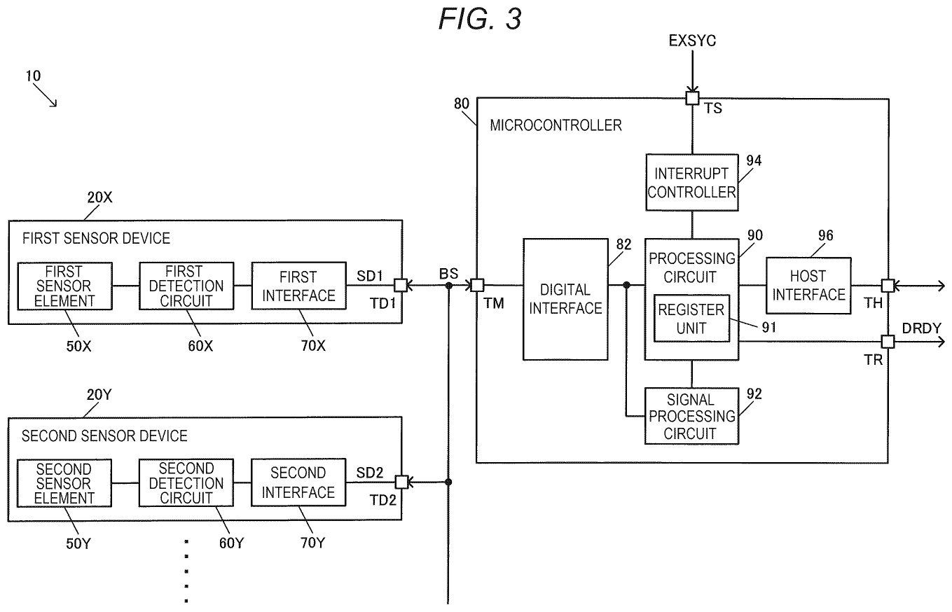

FIG. 3 shows a first exemplary configuration of the microcontroller 80. The microcontroller 80 includes a digital interface 82, a processing circuit 90, a signal processing circuit 92, an interrupt controller 94, and a host interface 96. The number of the sensor devices is set at n=2 in the description.

The digital interface 82 is a circuit that performs interfacing with the sensor devices. That is, the digital interface 82 performs interfacing as a master with respect to the first interface 70X and the second interface 70Y. The digital interface 82 is coupled to the digital interface bus BS via a terminal TM. The digital interface 82 performs interfacing that complies with the SPI or I2C communication standard, an advanced SPI or I2C communication standard, or a partially improved or modified SPI or I2C communication standard, as the first interface 70X and the second interface 70Y.

The signal processing circuit 92 is a circuit that performs digital signal processing such as the integration described above, and can be realized, for example, by a DSP. The signal processing circuit 92 integrates the first detected data SD1 received by the digital interface 82 to determine the first integrated data SDATC1, and integrates the second detected data SD2 received by the digital interface 82 to determine the second integrated data SDATC2. The signal processing circuit 92 may perform filtering or correction. Specifically, the signal processing circuit 92 may calculate the moving average of the latest J pieces of detected data, and then perform 1/K-rate down-sampling on the resultant detected data (J and K are each integer greater than or equal to two). The signal processing circuit 92 may further perform correction, such as temperature correction, on the filtered detected data. The signal processing circuit 92 may integrate the filtered or the corrected detected data to determine integrated data.

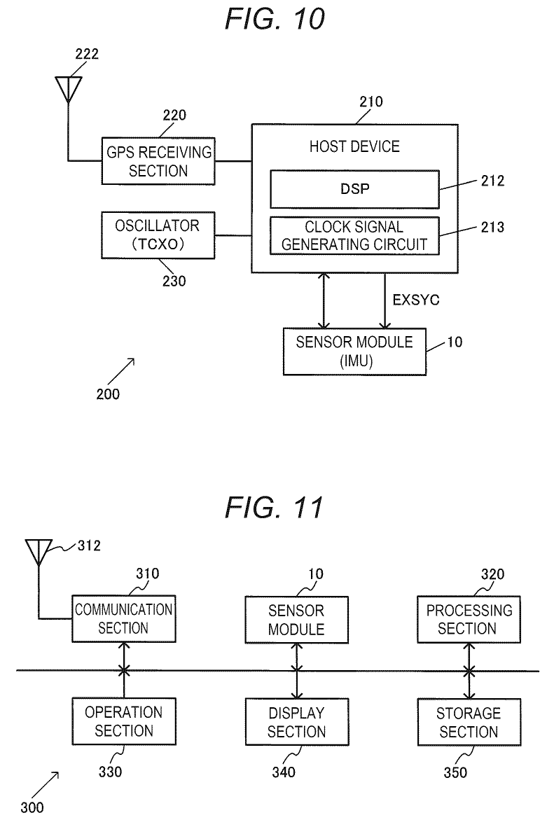

The processing circuit 90 is a circuit corresponding to a core CPU of the microcontroller 80, and performs various types of operation or control. The processing circuit 90 includes a register unit 91 including various registers. The processing circuit 90 saves the integrated data from the signal processing circuit 92 in the register unit 91. The processing circuit 90 then generates the signal DRDY, which is an integrated data preparation completion signal, and outputs the signal DRDY to a host device 210, which will be described later in FIG. 10, via a terminal TR. The signal DRDY is a signal indicating that the signal processing circuit 92 has completed the digital signal processing. Note that when the host interface 96 performs communication that complies with the UART standard, the signal DRDY may not be output to the host device 210.

The register unit 91 includes multiple registers that can be accessed externally. For example, the host device 210 can access a data register of the register unit 91 via the host interface 96, and read the integrated data. The processing circuit 90 may count the frequency indicating how frequently the data register for the integrated data has been updated, and write the counted update frequency to an update frequency register of the register unit 91. The host device 210 can thus identify how many sets of integrated data have been read from the microcontroller 80.

The interrupt controller 94 accepts various interrupt requests. The interrupt controller 94 then outputs signals that notify an interrupt request, an interrupt level, and a vector number to the processing circuit 90 in accordance with the priority and the interrupt level. The external synchronization signal EXSYC is input as one of the interrupt request signals to the interrupt controller 94 via a synchronization terminal TS. Upon acceptance of the interrupt request using the external synchronization signal EXSYC, the processing circuit 90 performs interrupt corresponding to the interrupt request. Note that examples of the interrupt request include an SPI or UART interrupt request from the host interface 96, interrupt requests from various timers, an I2C interrupt request.

The host interface 96 is a circuit that performs digital interfacing with the host device 210. For example, the host interface 96 performs serial data communication that complies, for example, with SPI, I2C, or UART as host interfacing.

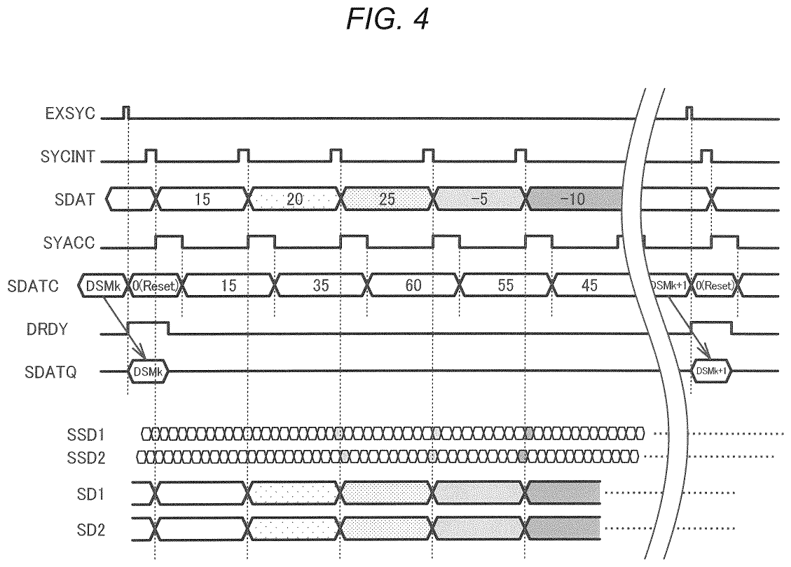

FIG. 4 is a signal waveform diagram for illustrating the operation of the sensor module 10. The number of the sensor devices is set at n=2 in the description. Note that data hatched in the same manner indicates data corresponding to each other.

The symbol SSD1 shown in FIG. 4 indicates detected data output by the first detection circuit 60X of the first sensor device 20X, and the symbol SSD2 indicates detected data output from the second detection circuit 60Y of the second sensor device 20Y. In the present embodiment, the first sensor device 20X and the second sensor device 20Y operate based on separate clock signals. For example, the sensor devices each operate based on a clock signal from an oscillation circuit built in the sensor device or a clock signal generated by using a vibrator such as a quartz crystal vibrator provided in the sensor device. The detected data SSD1 output by the first detection circuit 60X and the detected data SSD2 output from the second detection circuit 60Y are therefore out of synch with each other.

The interrupt controller 94 generates at regular intervals a signal SYCINT used to perform internal interrupt. The frequency of the signal SYCINT is lower than the rates at which the detected data SSD1 and SSD2 are sampled. The microcontroller 80 starts the internal interrupt at an edge timing of the signal SYCINT. The following description will be made with reference to a case where the internal interrupt starts at the falling timing of the signal SYCINT.

When the internal interrupt starts, the digital interface 82 receives the first detected data SD1 from the first interface 70X of the first sensor device 20X. The first detected data SD1 is data at the falling timing of the signal SYCINT out of the detected data SSD1 output by the first detection circuit 60X. The digital interface 82 further receives the second detected data SD2 from the second interface 70Y of the second sensor device 20Y. The second detected data SD2 is data at the falling timing of the signal SYCINT out of the detected data SSD2 output by the second detection circuit 60Y. Detected data SDAT received by the digital interface 82 is the first detected data SD1 or the second detected data SD2. Only one set of detected data is shown in FIG. 4, but the digital interface 82 receives each of the first detected data SD1 and the second detected data SD2.

When the internal interrupt starts, the processing circuit 90 generates a signal SYACC, which causes the signal processing circuit 92 to perform operation. FIG. 4 shows a case where the signal SYACC becomes active for a predetermined period from the falling edge of the signal SYCINT. It is assumed in the description that the signal SYACC is active when it has a high level. In each period for which the signal SYACC is active, the signal processing circuit 92 adds the detected data SDAT to integrated data SDATC at that point of time to update the integrated data SDATC in accordance with the result of the addition. The update is performed, for example, when the period for which the signal SYACC is active ends. The detected data SDAT is added whenever the internal interrupt is performed to generate the integrated data SDATC. Although FIG. 4 shows only one set of integrated data, the first detected data SD1 and the second detected data SD2 are each integrated, so that the first integrated data and the second integrated data are generated.

The interrupt controller 94 generates an external interrupt signal at an edge timing of the external synchronization signal EXSYC, and the microcontroller 80 starts external interrupt in response to the external interrupt signal. FIG. 4 shows a case where the external interrupt starts at the falling timing of the external synchronization signal EXSYC. When the external interrupt starts, the signal processing circuit 92 resets the integrated data SDATC to zero. The detected data SDAT is thus integrated from the edge timing of the external synchronization signal EXSYC to the next edge timing thereof. When the value of the detected data SDAT after the external synchronization signal EXSYC is input is 15, 20, 25, −5, −10, . . . , the value of the integrated data SDATC is 0, 0+15=15, 15+20=35, 35+25=60, 60−5=55, 55−10=45, . . . , as shown in FIG. 4. The integrated data SDATC immediately before reset at the edge timing of the external synchronization signal EXSYC is called DSMk and DSMk+1. The symbol k is an integer and is an index indicating how many edges of the external synchronization signal EXSYC have been used to generate the integrated data.

When the integrated data SDATC is reset, the processing circuit 90 saves the integrated data DSMk and DSMk+1 immediately before the reset operation in the register unit 91, and outputs the data ready signal DRDY to the host device 210. The host device 210 receives the data ready signal DRDY and issues a read request to the host interface 96, and the host interface 96 outputs the integrated data DSMk and DSMk+1 stored in the register unit 91 to the host device 210 as output data SDATQ. Note that when the host interface 96 performs communication that complies with the UART standard, the integrated data DSMk and DSMk+1 may be output to the host device 210 with the signal DRDY not output to the host device 210.

In the present embodiment, the sensor module 10 includes the first sensor device 20X, the second sensor device 20Y, and the microcontroller 80. The first sensor device 20X includes the first sensor element 50X, the first detection circuit 60X, which receives a signal input from the first sensor element 50X and performs detection, and the first interface 70X, which outputs the first detected data SD1 from the first detection circuit 60X. The second sensor device 20Y includes the second sensor element 50Y, the second detection circuit 60Y, which receives a signal input from the second sensor element 50Y and performs detection, and the second interface 70Y, which outputs the second detected data SD2 from the second detection circuit 60Y. The microcontroller 80 includes the synchronization terminal TS, to which the external synchronization signal EXSYC is input. The microcontroller 80 receives the first detected data SD1 input from the first sensor device 20X and the second detected data SD2 input from the second sensor device 20Y. The microcontroller 80 determines the first integrated data SDATC1 by integrating the first detected data SD1 up to the synchronization timing of the external synchronization signal EXSYC, determines the second integrated data SDATC2 by integrating the second detected data SD2 up to the synchronization timing, and outputs the first integrated data SDATC1 and the second integrated data SDATC2 to the host device at the synchronization timing.

According to the present embodiment, the data rate at which the integrated data is integrated is lower than the rate at which the detected data is sampled. The configuration in which the microcontroller 80 outputs the integrated data to the host device therefore reduces the load on the host device as compared with a configuration in which the detected data is output. For example, the communication load or the operation load such as the integration on the host device decreases. The host device performs, for example, communication with or control on various sensors or apparatuses provided in the system, reducing the load on the sensor module 10 allows the processing load to be allocated to other sensors or apparatuses.

Furthermore, according to the present embodiment, the microcontroller 80 outputs the integrated data to the host device in synchronization with the external synchronization signal EXSYC. The host device can thus acquire synchronized data, for example, from various sensors. That is, the host device can receive data from the sensor module 10, other sensors, and the like in synchronization with the external synchronization signal EXSYC, and can perform various types of processing, control, or other operation by using the synchronized data. For example, in autonomous navigation of a moving object, the position and posture of the moving object can be detected by using various synchronized sensor outputs.

In the present embodiment, the microcontroller 80 may determine the first: integrated data SDATC1 by integrating the first detected data SD1 for the period between the synchronization timings of the external synchronization signal EXSYC, and may determine the second integrated data SDATC2 by integrating the second detected data SD2 for the period between the synchronization timings.

In the present embodiment, the microcontroller 80 may reset the first integrated data SDATC1 and the second integrated data SDATC2 whenever the synchronization timing is reached.

According to the present embodiment, the host device can acquire data integrated for each period between the synchronization timings of the external synchronization signal EXSYC. The host device can use the integrated data regarded as the detected data from the sensor module 10, or can further perform integration or other processing on the integrated data and use the resultant data. For example, when the sensor device is an angular velocity sensor and the external synchronization signal EXSYC is PPS signal, the integrated data indicates the angle of rotation per second. That is, the integrated data can be regarded as angular velocity data expressed in dps. The host device can, for example, use the received integrated data as angular velocity data, or can further integrate the angular velocity data to determine the angle of rotation.

Furthermore, in the present embodiment, the microcontroller 80 may output a signal that notifies completion of the integration for the period between the synchronization timings to an external apparatus when the integration is completed. In the examples shown in FIGS. 2 and 4, the data ready signal DRDY is the “signal that notifies completion of the integration”.

According to the present embodiment, upon reception of the signal that notifies completion of the integration, the host device can perform communication for receiving the integrated data, and acquire the result of the completed integration.

In the present embodiment, the external synchronization signal EXSYC may be a time reference signal acquired from a satellite positioning system. The satellite positioning system is also called a global navigation satellite system (GNSS), and is, for example, a global positioning system (GPS), a quasi-zenith satellite system (QZSS), GLONASS, and Galileo.

According to the present embodiment, the microcontroller 80 can output the integrated data to the host device in synchronization with the time reference signal. For example, in a system that performs processing, control, or other operation in synchronization with the time reference signal, the host device can acquire data synchronized with the time reference signal from the sensor module 10 and perform the processing, control, or other operation.

### 2. Second Exemplary Configuration

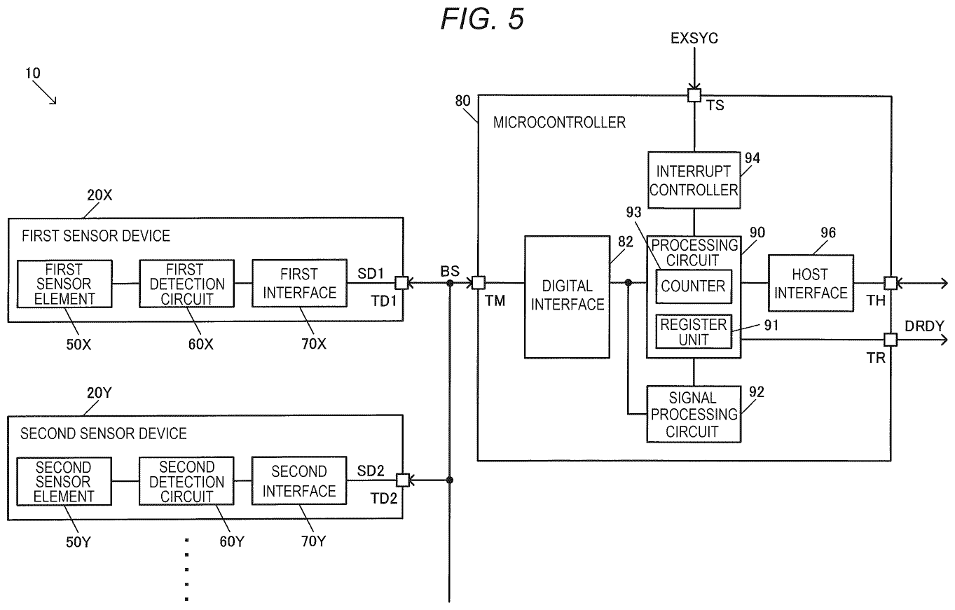

FIG. 5 shows a second exemplary configuration of the microcontroller 80. The elements having already been described have the same reference characters, and will not be described as appropriate. Portions of the second exemplary configuration that differ from those of the first exemplary configuration will be primarily described below. In the second exemplary configuration, the processing circuit 90 includes a counter 93.

The counter 93 starts counting a predetermined period from the synchronization timing of the external synchronization signal EXSYC. The microcontroller 80 includes an oscillation circuit that is not shown, and the counter 93 uses a clock signal from the oscillation circuit to perform the counting. Instead, the microcontroller 80 may receive a clock signal input from an external oscillation circuit, and the counter 93 may use the clock signal to perform the counting.

The register unit 91 stores set information indicating the predetermined period. The set information is, for example, information indicating a count value corresponding to the predetermined period. For example, the host device writes the set information to the register unit 91 via the host interface 96. The processing circuit 90 compares the count value of the counter 93 with the set information stored in the register unit 91 to determine whether the predetermined period has been counted.

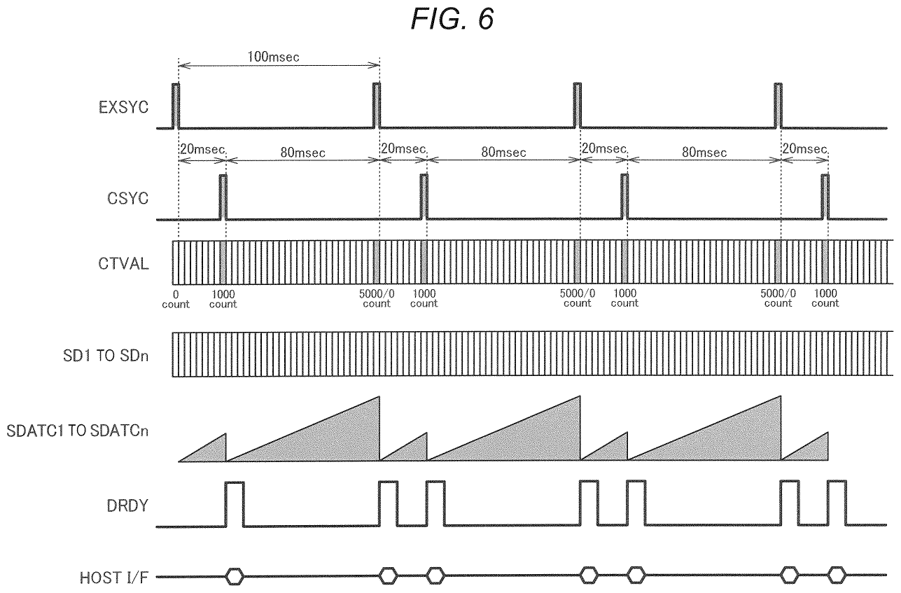

FIG. 6 is an exemplary timing chart for illustrating the operation of the microcontroller 80 in the second exemplary configuration. FIG. 6 shows a case where the 10-pulses/sec PPS signal is input as the external synchronization signal EXSYC to the microcontroller 80, the counter 93 counts at 50 kHz, and the predetermined period corresponds to 1,000 counts.

The processing circuit 90 resets a count value CTVAL of the counter 93 to zero at the edge timing of the external synchronization signal EXSYC. The counter 93 increments the count value CTVAL based on the 50-kHz clock signal. The processing circuit 90 generates an internal synchronization signal CSYC when the count value CTVAL coincides with 1,000 counts. The signal processing circuit 92 resets the integrated data SDATC1 to SDATCn at the edge timing of the external synchronization signal EXSYC and the edge timing of the internal synchronization signal CSYC. The signal processing circuit 92 integrates the detected data SD1 to SDn for the period from the edge timing of the external synchronization signal EXSYC to the edge timing of the internal synchronization signal CSYC and for the period from the edge timing of the internal synchronization signal CSYC to the edge timing of the external synchronization signal EXSYC to generate the integrated data SDATC1 to SDATCn.

The microcontroller 80 generates the data ready signal DRDY at each of the edge timing of the external synchronization signal EXSYC and the edge timing of the internal synchronization signal CSYC, and outputs the data ready signal DRDY to the host device. Upon reception of the data ready signal DRDY, the host device reads the first integrated data SDATC1 to the n-th integrated data SDATCn via the host interface of the microcontroller 80.

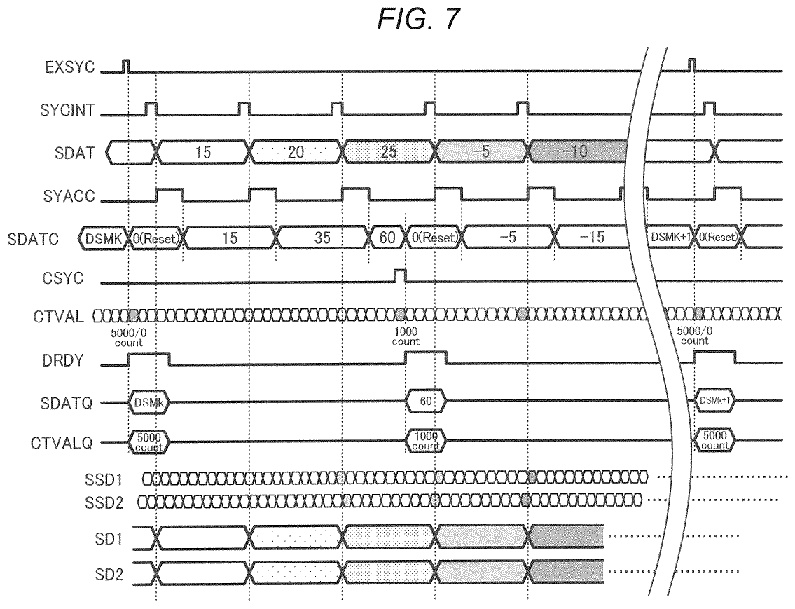

FIG. 7 is a signal waveform diagram for illustrating the operation of the sensor module 10 using the microcontroller 80 having the exemplary second configuration. The number of the sensor devices is set at n=2 in the description. Processes to be carried out before the microcontroller 80 receives the detected data SDAT from each of the sensor devices are the same as those in FIG. 4.

The interrupt controller 94 generates the external interrupt signal at the edge timing of the external synchronization signal EXSYC, and the microcontroller 80 starts the external interrupt in response to the external interrupt signal. FIG. 7 shows a case where the external interrupt process starts at the falling timing of the external synchronization signal EXSYC. When the external interrupt starts, the signal processing circuit 92 resets the integrated data SDATC to zero. Thereafter, in the period for which the signal SYACC is active, the signal processing circuit 92 adds the detected data SDAT to the integrated data SDATC.

The processing circuit 90 generates the internal synchronization signal CSYC when the count value CTVAL coincides with 1,000 counts, which indicates the predetermined period. The signal processing circuit 92 resets the integrated data SDATC to zero at an edge timing of the internal synchronization signal CSYC. FIG. 7 shows a case where the integrated data SDATC is reset at the falling timing of the internal synchronization signal CSYC. Thereafter, in the period for which the signal SYACC is active, the signal processing circuit 92 adds the detected data SDAT to the integrated data SDATC.

As described above, the detected data SDAT is integrated for the period from the edge timing of the external synchronization signal EXSYC to the edge timing of the internal synchronization signal CSYC and for the period from the edge timing of the internal synchronization signal CSYC to the edge timing of the external synchronization signal EXSYC. It is assumed that the value of the detected data SDAT after the external synchronization signal EXSYC is input is 15, 20, 25, −5, −10, . . . , and the internal synchronization signal CSYC is generated when SDAT=25, as shown in FIG. 7. In this case, the value of the integrated data SDATC is 0, 0+15=15, 15+20=35, and 35+25=60, and is reset by the internal synchronization signal CSYC, to 0, 0−5=−5, −5−10=−15, The integrated data SDATC immediately before reset at the edge timing of the external synchronization signal EXSYC and the edge timing of the internal synchronization signal CSYC is called DSMk, 60, and DSMk+1. The symbol k is an integer and is an index indicating how many edges of the external synchronization signal EXSYC have been used to generate the integrated data.

When the integrated data SDATC is reset, the processing circuit 90 saves the integrated data DSMk, 60, and DSMk+1 immediately before the reset operation and count values 5,000, 1,000, and 5,000 in the register unit 91, and outputs the data ready signal DRDY to the host device 210. The host device 210 receives the data ready signal DRDY and issues the read request to the host interface 96, and the host interface 96 outputs, to the host device 210, the integrated data DSMk, 60, and DSMk+1 stored in the register unit 91 as the output data SDATQ and the count values 5,000, 1,000, and 5,000 as output data CTVALQ. Note that when the host interface 96 performs communication that complies with the UART standard, the integrated data DSMk, 60, and DSMk+1 and the count values 5,000, 1,000, and 5,000 may be output to the host device 210 with the signal DRDY not output to the host device 210.

In the present embodiment, the microcontroller 80 determines the first integrated data SDATC1 by integrating the first detected data SD1 for the period between output timings including the synchronization timing of the external synchronization signal EXSYC and the timing after the predetermined period from the synchronization timing, and may determine the second integrated data SDATC2 by integrating the second detected data SD2 for the period between the synchronization timings.

According to the present embodiment, the microcontroller 80 can output the integrated data to the host device at any output timing as well as the synchronization timing of the external synchronization signal EXSYC. The host device may acquire data from a sensor or the like at various synchronization timings, in which case, the host device can acquire the integrated data from the sensor module 10 at the various synchronization timings, and can perform various types of processing, control, or other operation by using the synchronized data.

In the present embodiment, the sensor module 10 may include a register that stores the set information on the predetermined period. The microcontroller 80 may set a timing after the predetermined period based on the set information.

According to the present embodiment, the timing when the integrated data is output can be set at any timing by writing the set information to the register from an apparatus external to the sensor module 10.

In the present embodiment, the microcontroller 80 may reset the first integrated data SDATC1 and the second integrated data SDATC2 at each output timing.

According to the present embodiment, the integrated data is reset at each output timing, thus, the integrated data is data in which the detected data is integrated between the output timings. The host device can thus acquire data integrated for each period between output timings. The host device can use the integrated data regarded as the detected data from the sensor module 10, or can further perform integration or other processing on the integrated data and use the resultant data. For example, when the sensor device is an angular velocity sensor, the integrated data can be converted into an angle of rotation per second based on the integrated data and the period between the output timings, and used as angular velocity data expressed in dps. The host device can instead also determine the angle of rotation by further integrating the integrated data.

Furthermore, in the present embodiment, the microcontroller 80 may output a signal that notifies completion of the integration for the period between the output timings to an external apparatus when the integration is completed. In the examples shown in FIGS. 6 and 7, the data ready signal DRDY is the “signal that notifies completion of the integration”.

According to the present embodiment, upon reception of the signal that notifies completion of the integration, the host device can perform communication for receiving the integrated data, and acquire the result of the completed integration.

### 3. Sensor Device

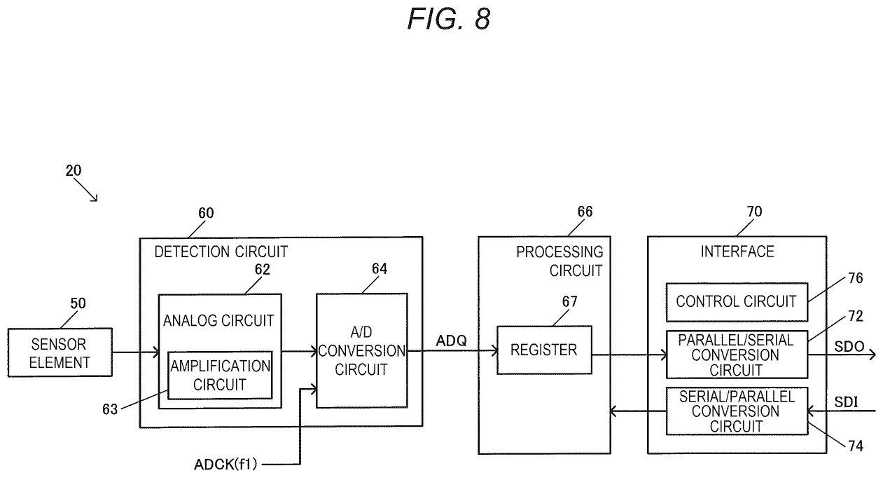

FIG. 8 shows an exemplary configuration of a sensor device 20. The sensor device 20 corresponds to each of the first sensor device 20X and the second sensor device 20Y shown in FIGS. 1, 3, and 5. The sensor device 20 includes a sensor element 50, a detection circuit 60, a processing circuit 66, and an interface 70.

The detection circuit 60 includes an analog circuit 62 including an amplification circuit 63, which amplifies a signal from the sensor element 50, and an A/D conversion circuit 64, which converts an analog signal from the analog circuit 62 into digital data. The processing circuit 66 includes a register 67. The interface 70 includes a parallel/serial conversion circuit 72, a serial/parallel conversion circuit 74, and a control circuit 76, which performs interface control.

The A/D conversion circuit 64 samples the analog detection signal from the analog circuit 62 based on a clock signal ADCK having a frequency f1 to perform A/D conversion. The A/D conversion circuit 64 outputs detected data ADQ at an output sampling rate corresponding to the frequency f1. The register 67 holds the detected data ADQ. The detected data ADQ output at the frequency f1 corresponds to the detected data SSD1 and SSD2 in FIGS. 4 and 7. When the A/D conversion resolution of the A/D conversion circuit 64 is k bits, the detected data ADQ is, for example, k-bit parallel data.

Serial data carried by a data input signal SD1 from the microcontroller 80 is converted into parallel data by the serial/parallel conversion circuit 74. The microcontroller 80 transmits a read command to the interface 70 at the edge of the signal SYCINT. When the interface 70 receives the read command, the parallel/serial conversion circuit 72 converts the detected data ADQ held in the register 67 into serial data, and outputs the serial data as a data output signal SDO to the microcontroller 80. The frequency of the signal SYCINT is f2<f1, and the interface 70 outputs the detected data ADQ at an output sampling rate corresponding to the frequency f2. The detected data ADQ output at the frequency f2 corresponds to the detected data SD1 and SD2 in FIGS. 4 and 7.

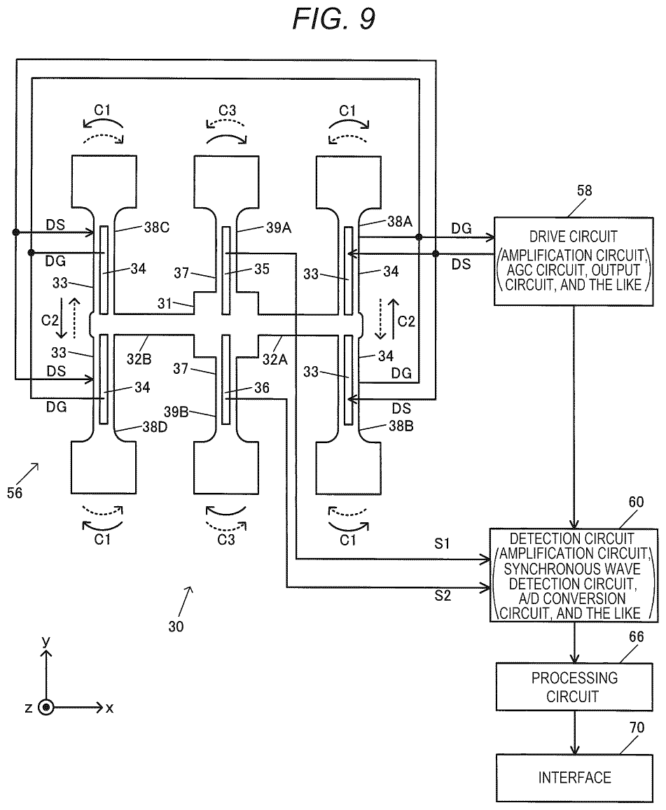

FIG. 9 shows an exemplary configuration of an angular velocity sensor device as an example of the sensor device. An angular velocity sensor device 30 includes a vibrator 56, a drive circuit 58, the detection circuit 60, the processing circuit 66, and the interface 70.

The drive circuit 58 may include an amplification circuit that receives a feedback signal DG input from the vibrator 56 and amplifies the signal, an AGC circuit that performs automatic gain control, an output circuit that outputs a drive signal DS to the vibrator 56, or other circuits. For example, the AGC circuit variably and automatically adjusts the gain in such a way that the amplitude of the feedback signal DG from the vibrator 56 becomes constant. The output circuit outputs the drive signal DS, which is, for example, a rectangular wave, to the vibrator 56. The detection circuit 60 may include an amplification circuit, a synchronous wave detecting circuit, an A/D conversion circuit, and other circuits. The amplification circuit receives detection signals S1 and S2 input from the vibrator 56 and performs charge-voltage conversion and signal amplification on the detection signals S1 and S2, which are differential signals. The synchronous wave detection circuit performs synchronous detection for extracting a desired wave by using a synchronization signal from the drive circuit 58. The A/D conversion circuit converts the analog detection signal after the synchronous wave detection into digital detected data and outputs the detected data to the processing circuit 66. The processing circuit 66 performs various types of processing on the detected data, such as zero point correction, sensitivity adjustment, filtering, or temperature correction, and outputs the processed detected data to the interface 70.

In FIG. 9, a vibrator having a double-T structure is used as the vibrator 56. Note that a tuning-fork-type, H-type, or any other suitable vibrator may be used as the vibrator 56. The vibrator 56 includes drive arms 38A, 38B, 38C, and 38D, detection arms 39A and 39B, a base 31, and linkage arms 32A and 32B. The detection arms 39A and 39B extend in a +y-axis direction and a-y-axis direction from the base 31, which has a rectangular shape. The linkage arms 32A and 32B extend in a +x-axis direction and a-x-axis direction from the base 31. The drive arms 38A and 38B extend in the +y-axis direction and the −y-axis direction from a front end portion of the linkage arm 32A, and the drive arms 38C and 38D extend in the +y-axis direction and the −y-axis direction from a front end portion of the linkage arm 32B. The drive arms 38A, 38B, 38C, and 38D and the detection arms 39A and 39B each have a frequency adjusting weight provided at the front end thereof. Assuming that the thickness direction of the vibrator 56 extends along a Z-axis, the vibrator 56 detects angular velocity around the Z-axis.

Drive electrodes 33 are formed at the upper and lower surfaces of each of the drive arms 38A and 38B, and drive electrodes 34 are formed at the right and left side surfaces of each of the drive arms 38A and 38B. The drive electrodes 34 are formed at the upper and lower surfaces of each of the drive arms 38C, 38D, and the drive electrodes 33 are formed at the right and left side surfaces of each of the drive arms 38C, 38D. The drive signal DS from the drive circuit 58 is supplied to the drive electrodes 33, and the feedback signal DG from each of the drive electrodes 34 is input to the drive circuit 58. Detection electrodes 35 are formed at the upper and lower surfaces of the detection arm 39A, and ground electrodes 37 are formed at the right and left side surfaces of the detection arm 39A. Detection electrodes 36 are formed at the upper and lower surfaces of the detection arm 39B, and the ground electrodes 37 are formed at the right and left side surfaces of the detection arm 39B. The detection signals S1 and S2 from the detection electrodes 35 and 36 are then input to the detection circuit 60.

The operation of the angular velocity sensor device 30 will next be described. When the drive circuit 58 applies the drive signal DS to the drive electrodes 33, the drive arms 38A, 38B, 38C, and 38D perform flexural vibration as indicated by arrows C1. The drive arms each repeat, for example, a vibration mode indicated by the solid arrows and a vibration mode indicated by the dotted arrows at a predetermined frequency. In this state, when angular velocity around the Z-axis, which serves as an axis of rotation, acts on the vibrator 56, the drive arms 38A, 38B, 38C, and 38D vibrate as indicated by arrows C2 due to a Coriolis force. The vibration indicated by the arrows C2 is transmitted to the base 31 via the linkage arms 32A and 32B, and the detection arms 39A and 39B perform the flexural vibration in the direction indicated by arrows C3. A charge signal generated due to the piezoelectric effect caused by the flexural vibration of the detection arms 39A and 39B is input as the detection signals S1 and S2 to the detection circuit 60, so that the angular velocity around the Z-axis is detected.

### 4. Measurement System

FIG. 10 shows an exemplary configuration of a measurement system 200 according to the present embodiment. The measurement system 200 includes the sensor module 10, and the host device 210 electrically coupled to the sensor module 10. The measurement system 200 may further include a GPS receiving section 220, an antenna 222 for GPS reception, and an oscillator 230. In FIG. 10, the sensor module 10 is used as a six-axis inertia measuring unit (IMU).

The host device 210 can be realized by any of various processors such as an MPU or a CPU. Note that the host device 210 may be realized by an ASIC-type integrated circuit unit. The host device 210 includes a digital signal processor (DSP) 212, which performs digital signal processing, and a clock signal generating circuit 213, which generates a clock signal.

The GPS receiving section 220 receives signals from GPS satellites via the antenna 222. That is, satellite signals carrying position information are received as a GPS carrier wave. The GPS receiving section 220 is a GPS receiver, and can be realized by an integrated circuit unit including a GPS receiving circuit. The host device 210 detects, based on the signals received by the GPS receiving section 220, GPS positioning data representing the position, the velocity, and the direction of an object under measurement, such as a moving object. The position of the object under measurement is the latitude, the longitude, the altitude, or the like. The GPS positioning data further contains status data indicating a reception state, a reception time, or the like. The host device 210 receives acceleration data and angular velocity data from the sensor module 10, and performs inertial navigation operation on the data to determine inertial navigation positioning data. The inertial navigation positioning data includes acceleration data and posture data of the object under measurement. The host device 210 then calculates the position, the posture, or both the position and the posture of the object under measurement based on the determined inertial navigation positioning data and the GPS positioning data. When the object under measurement is a moving object such as an automobile, the position on the ground where the moving object is traveling is calculated. The calculation of the position and the like of the object under measurement can be realized by Karman filtering using the DSP 212.

The oscillator 230 generates an oscillation clock signal by using a vibrator such as a quartz crystal vibrator. The oscillator 230 is, for example, a temperature compensated oscillator (TCXO). An oven-controlled oscillator (OCXO) including an oven may, for example, instead be used as the oscillator 230. The clock signal generating circuit 213 generates various clock signals to be used in the host device 210 based on the oscillation clock signal from the oscillator 230. In this case, the clock signal generating circuit 213 generates a clock signal based on the time reference signal, which is a signal acquired from the satellite positioning system such as the GPS. The clock signal generating circuit 213 generates, for example, the external synchronization signal EXSYC as one of the clock signals.

The host device 210 can acquire accurate absolute time information based on time information contained in the satellite signals received by the GPS receiving section 220. The time information is information such as a year, month, day, hour, minute, and second. The GPS receiving section 220 then outputs the PPS signal, which carries a pulse generated every second, as the time reference signal. The clock signal generating circuit 213 is configured with a PLL circuit that operates based on the oscillation clock signal from the oscillator 230, and the PPS signal is input as a clock synchronization reference signal to the PLL circuit. The PLL circuit then generates a clock signal synchronized with the PPS signal, which is the time reference signal. The host device 210 thus outputs the external synchronization signal EXSYC synchronized with the time reference signal to the sensor module 10. Note that the PPS signal from the GPS receiving section 220 may be input as the external synchronization signal EXSYC to the sensor module 10. The PPS signal does not necessarily provide one pulse per second, and may, for example, provide ten pulses per second, as shown in FIG. 2 and other figures.

### 5. Electronic Instrument

FIG. 11 shows an exemplary configuration of an electronic instrument 300 according to the present embodiment. The electronic instrument 300 includes the sensor module 10 according to the present embodiment and a processing section 320, which carries out processes based on a signal output from the sensor module 10. The electronic instrument 300 may further include a communication section 310, an operation section 330, a display section 340, a storage section 350, and an antenna 312.

The communication section 310 is, for example, a wireless circuit, receives data from an external apparatus, and transmits data to the external apparatus via the antenna 312. The processing section 320 controls the electronic instrument 300, digitally processes the data transmitted and received via the communication section 310 in various manners, and carries out other processes. The processing section 320 further carries out processes based on the signal output from the sensor module 10. Specifically, the processing section 320 performs signal processing such as correction or filtering on the signal output from the sensor module 10, such as the detected data, or performs various types of control on the electronic instrument 300 based on the output signal. The function of the processing section 320 can be realized, for example, by a processor such as an MPU or a CPU. The operation section 330 is used by a user to perform an input operation, and can be realized by operation buttons or a touch panel display. The display section 340 displays various pieces of information and can be realized, for example, by a display using a liquid crystal or organic EL material. The storage section 350 stores data, and the function thereof can be realized by a semiconductor memory such as a RAM or a ROM.

Note that the electronic instrument 300 according to the present embodiment is applicable, for example, to a video-related instrument such as a digital camera or a video camcorder, an in-vehicle instrument, a wearable instrument such as a head mounted display or a timepiece-related instrument, an inkjet-type discharge apparatus, a robot, a personal computer, a portable information terminal, a printing apparatus, or a projection apparatus. The in-vehicle instrument is, for example, a car navigator or an automatic driving instrument. The timepiece-related instrument is, for example, a timepiece or a smartwatch. The inkjet-type discharge apparatus is, for example, an inkjet printer. The mobile information terminal is, for example, a smartphone, a mobile phone, a mobile game console, a laptop PC, or a tablet terminal. The electronic instrument 300 according to the present embodiment is further applicable to an electronic organizer, an electronic dictionary, an electronic calculator, a word processor, a workstation, a videophone, a security television monitor, electronic binoculars, a POS terminal, a medical instrument, a fish-finder, a measurement instrument, an instrument for mobile terminal base station, meters and gauges, a flight simulator, and a network server. The medical instrument is, for example, an electronic thermometer, a blood pressure monitor, a blood glucose meter, an electrocardiogram measuring apparatus, an ultrasonic diagnostic apparatus, or an electronic endoscope. The meters and gauges are for a vehicle, an aircraft, a ship, and the like.

While the present embodiment has been described above in detail, a person skilled in the art can readily understand that many changes can be made thereto without substantially departing from the novel items and advantages of the present disclosure. All such variations therefore fall within the scope of the present disclosure. For example, a term described at least once together with a different term having a broader meaning or the same meaning in the specification or the drawings can be replaced with the different term at any place in the specification or the drawings. All combinations of the present embodiment and the variations thereof also fall within the scope of the present disclosure. The configurations and operations of the sensor element, the detection circuit, the interface, the sensor device, the digital interface, the processing circuit, the signal processing circuit, the interrupt controller, the host interface, the microcontroller, the host device, the measurement system, the electronic instrument, and the like are not limited to those described in the present embodiment, and can be changed in various manners.

What is claimed is:

1. A sensor module comprising:
a first sensor device including a first sensor element, a first detection circuit configured to receive a signal input from the first sensor element and perform detection, and a first interface configured to output first detected data from the first detection circuit;
a second sensor device including a second sensor element, a second detection circuit configured to receive a signal input from the second sensor element and perform detection, and a second interface configured to output second detected data from the second detection circuit; and
a microcontroller including a synchronization terminal to which an external synchronization signal is input and configured to receive the first detected data input from the first sensor device and the second detected data input from the second sensor device,
wherein the microcontroller is configured to determine first integrated data by integrating the first detected data up to a synchronization timing of the external synchronization signal, determine second integrated data by integrating the second detected data up to the synchronization timing, and output the first integrated data and the second integrated data to a host device at the synchronization timing.

2. The sensor module according to claim 1, wherein
the microcontroller is configured to determine the first integrated data by integrating the first detected data for a period between the synchronization timings of the external synchronization signal, and determine the second integrated data by integrating the second detected data for the period between the synchronization timings.

3. The sensor module according to claim 2, wherein
the microcontroller is configured to reset the first integrated data and the second integrated data whenever the synchronization timing is reached.

4. The sensor module according to claim 2, wherein
the microcontroller is configured to output a signal that notifies completion of the integration to an external apparatus when the integration between the synchronization timings is completed.

5. The sensor module according to claim 1, wherein
the microcontroller is configured to determine the first integrated data by integrating the first detected data for a period between output timings including the synchronization timing of the external synchronization signal and a timing after a predetermined period from the synchronization timing, and determine the second integrated data by integrating the second detected data for the period between the output timings.

6. The sensor module according to claim 5, further comprising
a register configured to store set information on the predetermined time,
wherein the microcontroller is configured to set a timing after the predetermined time based on the set information.

7. The sensor module according to claim 5, wherein
the microcontroller is configured to reset the first integrated data and the second integrated data whenever the output timing is reached.

8. The sensor module according to claim 5, wherein
the microcontroller is configured to output a signal that notifies completion of the integration to an external apparatus when the integration between the output timings is completed.

9. The sensor module according to claim 1, wherein
the external synchronization signal is a time reference signal acquired from a satellite positioning system.

10. A measurement system comprising:
the sensor module according to claim 1; and
the host device electrically coupled to the sensor module.

11. The measurement system according to claim 10,
wherein
the host device is configured to determine at least one of a position and a posture of a moving object based on positioning information from a satellite positioning system and a signal output from the sensor module.
